(19) United States
(12) Patent Application Publication
(10) Pub. No.: US 2003/0178270 A1
(43) Pub. Date: Sep. 25, 2003

(54) Drum brake

(76) Inventors: Herbert Vollert, Vaihingen/Enz (DE); Willi Nagel, Remseck/Hochdorf (DE); Bertram Foitzik, Ludwigsburg (DE); Rolf Knecht, Ditzingen (DE)

Correspondence Address: RONALD E. GREIGG, GREIGG & GREIGG P.L.L.C., Unit One, 1423 Powhatan Street, Alexandria, VA, 22314, US

(21) Appl. No.: 10/372,322

(22) Filed: Feb. 25, 2003

(30) Foreign Application Priority Data
Feb. 28, 2002 (DE) 1 02 09 001.7

(51) Int. Cl. F16D 51/00

(52) U.S. Cl. 188/325; 188/264 R

(57) ABSTRACT

The improved drum brake includes an anchor plate, a drum, and a drum ring and brake shoes, which cooperate with the drum and are disposed in a drum chamber between the anchor plate and the drum, and ventilation openings on the drum.

### BACKGROUND OF THE INVENTION

1. Field of the Invention

The invention is directed to an improved drum brake, and more particularly to such a drum brake having improved cooling means.

2. Description of the Prior Art

Drum brakes of this type are known in the industry and can be used as a brake device on a wheel of a motor vehicle. This kind of known drum brake, which can for instance be of the simplex, duplex, duo-duplex, servo, or duo-servo type, typically includes an anchor plate, which is screwed to a wheel hub, and a drum, which can be connected to a rim of a wheel. Between the anchor plate and the drum, a drum chamber is embodied, in which brake shoes are disposed that can be pressed against a ring of the drum via actuating means also disposed in the drum chamber and thus cause a deceleration of the affected motor vehicle. A brake lining is disposed on each of the brake shoes. The drum and the anchor plate overlap, so that the drum chamber is encapsulated.

During a braking event, the components of the drum brake heat up from the friction that occurs between the brake shoes and the drum. The thermal energy thus generated has to flow through the drum before it is dissipated to the ambient air or adjacent components.

In known drum brakes, there is the disadvantage that the drum expands when heated. As a result, the radius of curvature of the brake lining no longer matches the radius of curvature of the inside of the drum ring, which causes the original area contact between the brake lining and the drum ring to change into a so-called linear contact. This leads to local overheating of the brake lining. The overheating in turn causes a drop in friction of the brake lining, thus lessening the braking power that can be attained with the drum brake. This process, known as fading, is unwanted.

In the drum brakes known in the industry, there is also the disadvantage that moisture that may get into the drum chamber can escape only poorly. The components of the brake disposed in the drum chamber thus dry off poorly. At low ambient temperatures, for instance, this can cause the brake linings to freeze solidly to the drum while the vehicle is parked.

Another problem with known drum brakes is soiling of the drum chamber with abrasion from the linings, because the material abraded from the linings cannot be removed from the drum chamber.

### OBJECT AND SUMMARY OF THE INVENTION

The drum brake of the invention, in which ventilation openings are embodied on the drum, has the advantage over a drum brake of the prior art as described above, of a significantly higher thermal capacity, since via the ventilation openings, cooling of essential components of the drum brake, especially the drum or the drum ring, can be accomplished, which in turn lessens the tendency to so-called fading of the drum brake or even prevents such behavior of the brakes.

In a preferred embodiment of a drum brake of the invention, the drum ring includes an inner ring and an outer ring, between which ventilation openings are disposed. In this way, ventilation and hence cooling of the drum ring can be created in particular, which proves especially favorable to prevent fading, because additional cooling of the drum ring is always present.

The drum brake of the invention can be embodied either as a drum brake with an encapsulated drum chamber, that is, with a closed drum bottom, or as a drum brake with an open drum chamber.

Particularly if the drum chamber is encapsulated, the drum ring adjoining the drum bottom can advantageously be embodied such that the ventilation openings are each separated by ribs that join the inner and outer rings to one another and that are positioned on the order of a fan blade of an axial fan. This brings about especially effective ventilation and cooling of the drum ring.

In the case of an encapsulated drum chamber, the inner ring of the drum ring can be sealed off via a labyrinth seal, for instance, in the region of the transition to the anchor plate.

In addition or alternatively, the drum brake of the invention can be provided with ventilation openings embodied on the drum bottom that lead to the drum chamber. In that case, the drum brake is an open drum brake, in which cooling of the components disposed in the drum chamber is accomplished.

Effective ventilation of the drum chamber can be achieved if the ventilation openings on the drum bottom that lead to the drum chamber are each provided with a fan blade. In this case, the drum, which is open in the axial direction, functions on the order of an axial fan.

In an expedient embodiment, in the case of an open drum brake, a substantially annular ventilation gap is disposed between the drum ring and the anchor plate. Via this ventilation gap, cooling air can be delivered to the drum chamber or removed from the drum chamber.

In a special embodiment, a drum brake of the invention can be equipped with a separate fan impeller. The fan impeller is for instance supported on the anchor plate or the drum via a slide bearing or a roller bearing.

In this embodiment, it is possible for the fan impeller to be operated only as needed, which is advantageous in terms of fuel consumption of the affected motor vehicle, because the cooling operation effected by means of the fan impeller leads to increased energy consumption.

It is therefore expedient if the drum brake is equipped with a driver device, which couples the fan impeller with the drum as a function of the operating temperature of the drum.

A driver device of this kind can for instance include a cartridge, which has a filling that expands with increasing temperature and acts on a bolt. When a certain limit temperature is reached, the bolt engages the fan impeller and imposes the rpm of the drum onto it.

In the case of an open drum brake of the invention, it proves advantageous if the brake shoes are each provided with at least one ventilation conduit. The ventilation conduit, which can be embodied as being at an angle relative to the pivot axis of the drum, brings about cooling of the affected brake shoe.

The ventilation conduits should be dimensioned sufficiently large that dirt cannot be firmly deposited in them, or that dirt is carried out of the ventilation conduits by the cooling air introduced into the drum chamber. In that case, there is a so-called self-cleaning effect.

Moreover, at least one axially oriented parting seam can be embodied on the operative side of each of the brake shoes. The parting seam, which divides the applicable brake lining, has the effect that the inner cylindrical surface of the drum ring is covered by the brake linings to a lesser extent, by comparison with a conventional brake shoe, so that the inner cylindrical face of the drum ring that is engaged by the brake shoes or brake linings can be bathed to a greater extent during a braking event by cooling air introduced into the drum chamber, which in turn leads to more pronounced cooling of the drum ring.

The ventilation conduits and parting seams moreover make it possible for the cooling air introduced into the drum chamber to bathe or flow through the respective brake lining or brake shoe.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a fragmentary section through a first embodiment of a drum brake of the invention, in perspective;

FIG. 2 is a rear view of the drum brake of FIG. 1;

FIG. 3 is a fragmentary section through a second embodiment of a drum brake of the invention;

FIG. 4 is a rear view of the drum brake of FIG. 3 in a fragmentary sectional view; and

FIG. 5 is a fragmentary section through a third embodiment of a drum brake of the invention.

### DESCRIPTION OF THE PREFERRED EMBODIMENTS

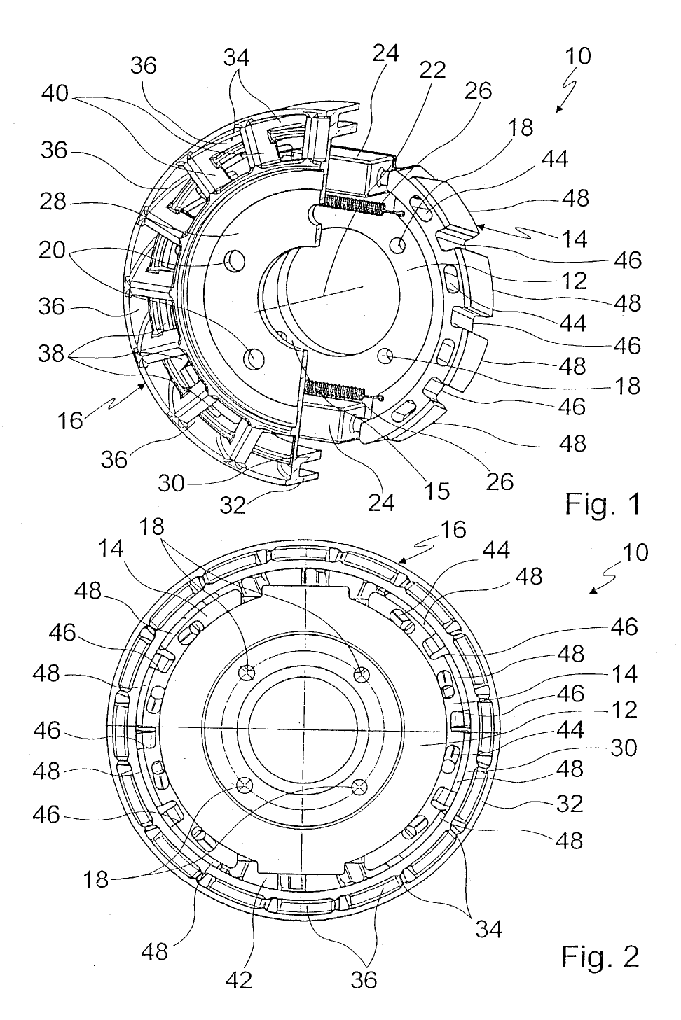

In FIGS. 1 and 2, a drum brake 10 is shown, which includes an anchor plate 12, brake shoes 14 secured to the anchor plate 12, and a drum 16. Between the anchor plate 12 and the drum 16 is a drum chamber 15, in which the brake shoes 14 are arranged. The anchor plate 12 can be connected to a wheel hub, not shown in detail here, via bores 18. The drum 16 is in turn connectable via bores 20 to a rim, also not shown in detail here, and is rotatable about an axle 22 represented by dashed lines.

The drum brake 10 is also provided with actuating devices 24, which act on the brake shoes 14 and can thus bring about a nonpositive engagement between the brake shoes 14 and the drum 16. In an unactuated state of the drum brake 10, tension springs 26 assure an air play between the drum 16 and the brake shoes 14.

The drum 16 includes a drum bottom 28, on which the bores 20 are embodied, and a drum ring, comprising an inner ring 30 and an outer ring 32. The inner ring 30 and the outer ring 32 are connected to one another via ribs 34, which are positioned in the manner of a fan blade of an axial fan. Thus ventilation openings 36 remain between the inner ring 30 and the outer ring 32 and accomplish a ventilation of the double-walled drum ring.

Also disposed on the drum bottom 28 are ventilation openings 38, whose number corresponds to that of the ventilation openings 36, and by way of which cooling air can be introduced into the drum chamber 15, which is defined by the drum bottom 28 and the anchor plate 12 and in which the brake shoes 14, among other elements, are disposed. The ventilation openings 38 are separated from one another by ribs 40, which are aligned with the ribs 34 connecting the inner ring 30 and the outer ring 32 to one another, and are thus also embodied as fan blades.

The inner ring 30, outer ring 32, and ribs 34 and 40 approximately form a structure of an annular double-T-beam profile, which is a rigid construction and thus leads to a sufficiently rigid drum 16.

Because of the embodiment of the ventilation openings 36 and 38 and of the ribs 34 and 40 acting as fan blades, the result upon rotation of the drum 16 is a large area of the drum ring that is bathed by cooling air and in turn leads to a high cooling output that acts on the inner ring 30.

To make it possible for the cooling air introduced into the drum chamber between the anchor plate 12 and the drum bottom 28 to be pumped out of the drum chamber 15 again, the drum chamber 15 is opened on the side of the anchor plate 12 via an annular gap 42, which is located between the anchor plate 12 and the inner ring 30.

In the present exemplary embodiment, the drum 16 has a triple function, namely as a rotating friction partner for the brake shoes 14; as an axial fan for the drum chamber 15 disposed between the anchor plate 12 and the drum bottom 28 and for the ventilation openings, or slits 36; and as an actively air-cooled cooling body.

In the present embodiment, the drum 16 is made from aluminum with a ceramic component, such as Al-MMC. Aluminum offers good thermal conductivity, is corrosion-resistant, and has a low weight. The ceramic component assures the requisite wear resistance of the drum 16.

The brake shoes 14 of the drum brake 10 have ventilation conduits 44, which are oriented at an angle to the axle 22 and are embodied as oblong slots.

In addition, parting seams 46 are embodied on the operative side of the brake shoes 14 and divide brake lining portions 48 from one another. The parting seams 46 and ventilation conduits 44 cause a bathing flow around or through the brake lining portions 48 or brake shoes 14.

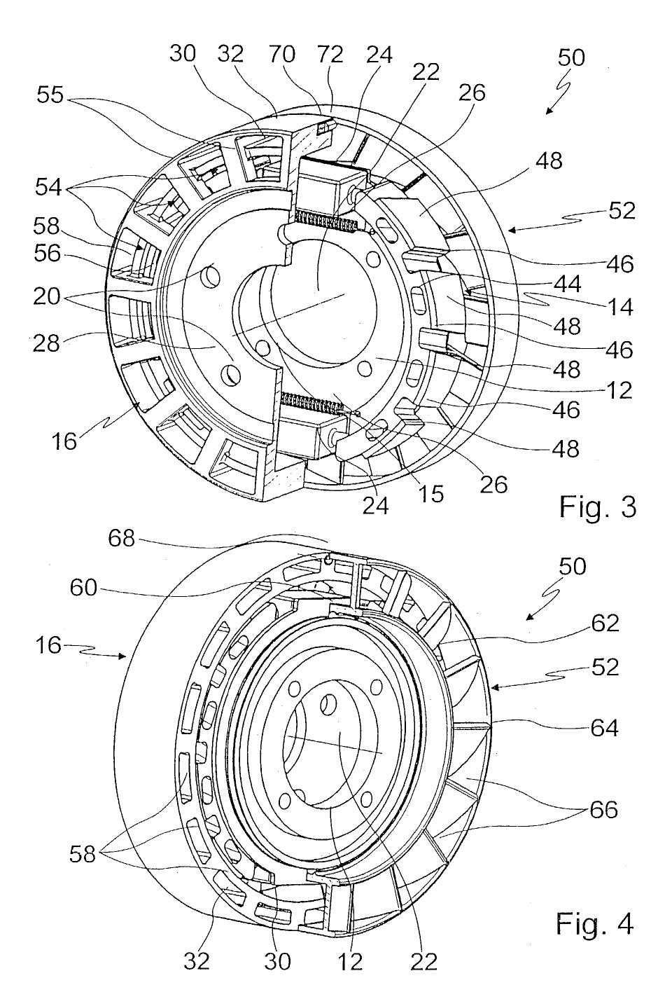

In FIGS. 3 and 4, an alternative embodiment of a drum brake 50 is shown, which is also embodied as an open drum brake but which differs from the drum brake of FIGS. 1 and 2 both in the embodiment of the drum 16 and in having an additional fan impeller 52. In FIGS. 3 and 4, the same reference numerals as in FIGS. 1 and 2 have been chosen for functionally identical components.

The drum 16 here has a drum bottom 28 on which bores 20 for fixation of a rim, not shown here, and ventilation openings 54 are embodied, making the drum 16 axially open. The ventilation openings 54 are separated from one another by radially oriented ribs 55, which lead to a drum ring that comprises an inner ring 30 and an outer ring 32. The ribs 55 each have axially oriented lateral boundary faces.

The ventilation openings 54 are each subdivided into two regions, namely one region 56, leading to a drum chamber 15 disposed between the drum bottom 28 and an anchor plate 12, and a slit 58, disposed between the inner ring 30 and the outer ring 32, that accordingly extends axially through the drum ring made up of the inner ring 30 and the outer ring 32.

Brake shoes 14 are disposed on the anchor plate 12; they are located in the drum chamber 15, and their embodiment corresponds to that of the brake shoes of the drum brake of FIGS. 1 and 2, and upon actuation of the drum brake 50, they are in operative communication with the inner cylindrical surface of the inner ring 30 via the brake linings 48.

The rectilinear connecting ribs 55 of the drum 16 have no air-guiding effect. For that purpose, however, the fan impeller 52, which acts as an axial fan, is supported on the anchor plate 12 via a slide or roller bearing 60. The fan impeller 52 has the same pivot axis 22 as the drum 16.

The fan impeller 52 includes an inner fan ring 62 and an outer fan ring 64, which are connected with one another via connecting ribs 66 embodied and positioned as fan blades. The supporting of the fan impeller 52 on the anchor plate 60 is effected via the inner fan ring 62.

At low temperatures of the drum 16 or of the drum ring comprising the inner ring 30 and the outer ring 32, the drum 16 and the fan impeller 52 are decoupled from one another. Thus upon a rotary motion of the drum 16, there is no transmission of torque to the fan impeller 52, which on the contrary remains in its position of repose. Upon heating of the drum 16 occurring in a braking event to above a limit temperature to be defined, however, coupling of the fan impeller 52 to the drum 16 takes place, so that a rotation of the drum 16 is transmitted to the fan impeller 52, and by means of the fan impeller 52, cooling air is pumped through the drum chamber 15 and the slits 58 in the drum ring.

The coupling of the fan impeller 52 to the drum 16 is effected by means of a cartridge, which has a filling 70 that expands under heat and that acts on a bolt 72, which beyond the limit temperature engages the fan impeller 52 and imposes the rpm of the drum upon it. The now-rotating fan impeller 52 either draws or presses cooling air, depending on the direction of rotation, through the opened drum brake 50.

This embodiment has the advantage that the fan impeller 52 is not activated until active cooling of the drum brake 50 is necessary. Since as a rule this occurs rarely or only briefly, the separate fan impeller 52 causes no additional fuel consumption. Moreover, essential components of the drum brake 50 are disposed in protected fashion between the wheel rim, secured to the drum 16 but not shown here, and the fan impeller 52. The wheel rim and the fan impeller 52 thus form a kind of shield on both sides to protect against gravel and splashing water.

In a modification, not shown in detail here, of the exemplary embodiment of FIGS. 3 and 4, a fan impeller can be supported not on the anchor plate but rather, via a suitable bearing, on the side of the drum bottom on the drum. In this embodiment, the cartridge comprising the filling and the bolt is once again disposed on the side of the drum bottom. The drum that rotates during vehicle operation can drive the fan impeller to rotate at most at the level of the bearing friction moment. Up to that point, the drum and the fan impeller rotate at the same rpm. If the drum rpm continues to increase, the fan impeller remains at its original rpm, or so-called limit rpm. This rpm corresponds with the bearing friction moment. Depending on the bearing friction moment, the limit rpm is low and is thus reached quickly. If the drum heats up, the bolt of the cartridge shifts in the direction of the fan impeller. Beyond a certain temperature, the bolt touches the fan impeller and carries it along with it. The drum and the fan impeller then rotate at the same rpm, so that effective ventilation or cooling of the drum brake is accomplished.

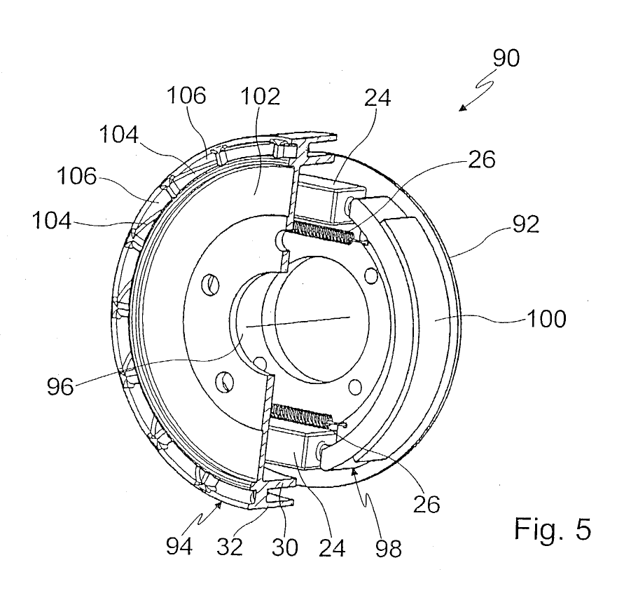

In FIG. 5, a further embodiment of a drum brake 90 of the invention is shown, which is constructed essentially in the manner of a conventional, closed drum brake, and which has an anchor plate 92 that together with a drum 94 defines a drum chamber 96, in which among other elements brake shoes 98, each with a brake lining 100, are disposed; these brake shoes can be actuated via actuating means 24 and are kept by tension springs 26 in an unactuated state such that an air play between the drum 94 and the brake linings 100 is assured.

The drum 94 includes a drum bottom 102, whose radial boundary is adjoined by a drum ring that comprises an inner ring 30 and an outer ring 32. The drum ring is sealed off from the anchor plate 92 via a labyrinth seal, not shown in further detail here, so that the drum chamber 96 is encapsulated.

The inner ring 30 and the outer ring 32 of the drum ring are joined together via ribs 104 positioned in the manner of fan blades, so that the drum 94 is provided with ventilation openings 106 embodied as slits, which are distributed regularly over the circumference of the drum 94. Upon a rotation of the drum 94, the slits 106 are actively ventilated by means of the fan blades 104, which leads to cooling of the drum ring. Compared to a conventional drum brake, the ventilation of the drum ring leads to a substantial increase in the thermal capacity.

The foregoing relates to preferred exemplary embodiments of the invention, it being understood that other variants and embodiments thereof are possible within the spirit and scope of the invention, the latter being defined by the appended claims.

We claim

1. A drum brake comprising
an anchor plate (12, 92),
a drum (16, 94),
a drum ring (30, 32)
brake shoes (14, 98), which cooperate with the drum (16, 94) and are disposed, between the anchor plate (12, 92) and the drum (16, 94), in a drum chamber (15, 96), and
ventilation openings (36, 38; 54; 106) embodied on the drum (16, 94).

2. The drum brake of claim 1, wherein the drum ring comprises an inner ring (30) and an outer ring (32), between which the ventilation openings (36; 38; 106) are disposed.

3. The drum brake of claim 1, wherein the ventilation openings (36, 38; 106) each comprise a fan blade (40; 104), each of which fan blade forms a dividing rib between two ventilation openings (36, 38; 106).

4. The drum brake of claim 2, wherein the ventilation openings (36, 38; 106) each comprise a fan blade (40; 104), each of which fan blade forms a dividing rib between two ventilation openings (36, 38; 106).

5. The drum brake of claim 1, further comprising a labyrinth seal sealing off the drum ring (30, 32) from the anchor plate (92).

6. The drum brake of claim 2, further comprising a labyrinth seal sealing off the drum ring (30, 32) from the anchor plate (92).

7. The drum brake of claim 3, further comprising a labyrinth seal sealing off the drum ring (30, 32) from the anchor plate (92).

8. The drum brake of claim 1, further comprising ventilation openings (38, 56) leading to the drum chamber (15).

9. The drum brake of claim 8, wherein the ventilation openings (38, 56) leading to the drum chamber (15) are embodied on the drum bottom (28).

10. The drum brake of claim 1, further comprising a substantially annular ventilation gap (42) located between the drum ring (30, 32) and the anchor plate (12).

11. The drum brake of claim 1, further comprising a fan impeller (16, 52) for pumping cooling air through the ventilation openings.

12. The drum brake of claim 11, wherein the fan impeller is formed by the drum (16).

13. The drum brake of claim 11, wherein the fan impeller (52) is supported on the anchor plate (12).

14. The drum brake of claim 11, wherein the fan impeller is supported on the drum.

15. The drum brake of claim 13, further comprising a driver device (68) operable to couple the fan impeller (52) with the drum (16) as a function of the operating temperature of the drum (16).

16. The drum brake of claim 14, further comprising a driver device (68) operable to couple the fan impeller (52) with the drum (16) as a function of the operating temperature of the drum (16).

17. The drum brake of claim 15, wherein the driver device comprises a cartridge (68), which has a filling (70) that expands with increasing temperature and acts on a bolt (72).

18. The drum brake of claim 1, wherein the brake shoes (14) each comprise at least one ventilation conduit (44).

19. The drum brake of claim 18, wherein the ventilation conduits (44) in the brake shoes (14) are oriented at an angle relative to the pivot axis (22) of the drum (16).

20. The drum brake of claim 1, wherein the brake shoes (14) each comprise at least one parting seam (46) on their effective side.
